(19) United States
(12) Patent Application Publication
(10) Pub. No.: US 2024/0336703 A1
(43) Pub. Date: Oct. 10, 2024

(54) METHOD OF PRODUCING LIGNIN OIL AND DISSOLVING CELLULOSE FROM LIGNOCELLULOSIC BIOMASS FEEDSTOCK

(71) Applicant: REN FUEL K2B IPCO AB, STOCKHOLM (SE)

(72) Inventors: Kiran Reddy BADDIGAM, STOCKHOLM (SE); Davide DI FRANCESCO, Wädenswil (CH); Kuntawit WITTHAYOLANKOWIT, STOCKHOLM (SE); Suthawan MUANGMEESRI, DJURSHOLM (SE); Daria LEBEDEVA, STOCKHOLM (SE); Joseph SAMEC, STOCKHOLM (SE)

(21) Appl. No.: 18/578,695

(22) PCT Filed: Jul. 13, 2022
(86) PCT No.: PCT/EP2022/069672

§ 371 Date: Jan. 11, 2024

(30) Foreign Application Priority Data
Aug. 17, 2021 (EP) 21191768.7

(51) Int. Cl. C08B 1/00; C07G 1/00; C08B 16/00; D01C 1/00

(52) U.S. Cl. CPC C08B 1/003; C07G 1/00; C08B 16/00; D01C 1/00

(57) ABSTRACT

A method of producing lignin oil and dissolving cellulose from a lignocellulosic biomass feedstock is disclosed. The method enables obtaining both lignin oil and dissolving cellulose from the lignocellulosic biomass feedstock, wherein the dissolving cellulose preferably is not contaminated with any metal catalyst when used in the method.

### FIELD OF THE INVENTION

The present invention relates to a method of producing lignin oil and dissolving cellulose from lignocellulosic biomass feedstock. The inventive method enables obtaining both lignin oil and dissolving cellulose from the lignocellulosic biomass feedstock, wherein the dissolving cellulose preferably is not contaminated with any metal catalyst when such catalyst is being used in the method.

### BACKGROUND ART

Dissolving cellulose is cellulose which is intended to be dissolved, especially for the production of textile fibers, such as viscose and lyocell, from the dissolved cellulose. Dissolving cellulose has a high cellulose content, typically of more than 90%. In the art, dissolving cellulose is also referred to as dissolving pulp. Different methods of producing dissolving cellulose from wood raw material are known in the art, such as the sulfite process, the Kraft process, and the organosolv process, which latter process uses an organic solvent to solubilise lignin and hemicellulose. Different types of organosolv pulping processes have been developed, using different organic solvents, such as e.g. a mixture of a C1-C4 alcohol, dioxane, or acetone, with water. Ethanol and methanol are two alcohols commonly used in organosolv pulping processes. Producing dissolving cellulose from wood using an organosolv pulping process is rather costly, and, as such, does not constitute a viable economical option for producing dissolving cellulose. Accordingly, it would be desirable to provide a more economically favourable route for production of dissolving cellulose from lignocellulosic biomass feedstock. It is an object of the present invention to provide such method.

### SUMMARY OF THE INVENTION

The present invention relates to a method that produces both a pulp suitable to convert to a textile fiber, i.e. a dissolving pulp, and a lignin oil that can be converted to monomers and/or hydrocarbons, such as for example aromatic and/or naphthenic hydrocarbons of which at least 80% can be distilled in the C6-C18 range, from a lignocellulosic biomass feedstock.

In a first aspect, the invention relates to a method of producing dissolving cellulose and lignin oil from a lignocellulosic biomass feedstock in particulate form comprising the following steps: A providing a particulate lignocellulosic biomass feedstock; B providing a first solvent comprising water; C contacting the lignocellulosic biomass feedstock with the first solvent under conditions in terms of temperature and pressure effective for removing hemicellulose contained in the lignocellulosic biomass feedstock, thereby freeing lignin contained in the lignocellulosic biomass feedstock from hemicellulose, and obtaining a solvent mixture containing hemicellulose and hemicellulose derived compounds; D providing a second solvent comprising a low-boiling liquid organic compound; E contacting the lignocellulosic biomass feedstock with the second solvent under conditions in terms of temperature and pressure effective for removing lignin contained in the lignocellulosic biomass feedstock, which lignin has been freed from hemicellulose, thereby obtaining a solvent mixture containing lignin and lignin derived compounds, and a delignified lignocellulosic biomass feedstock; F separating out a lignin oil from the solvent mixture containing lignin and lignin derived compounds obtained in step E; G disintegrating the delignified lignocellulosic biomass feedstock resulting from step E, so as to obtain an unbleached pulp; H bleaching of the unbleached pulp obtained in step G, so as to obtain a bleached pulp; wherein the particulate lignocellulosic biomass feedstock is in the form of a course particulate lignocellulosic biomass feedstock, and the delignification in step E is carried out until a degree of delignification of the lignocellulosic biomass feedstock of up to 94% is accomplished.

The inventive dissolving cellulose is the product resulting from step H.

In addition to lignin oil and dissolving cellulose, hemicellulose and hemicellulose derived compounds can be separated as products using the inventive method.

In one embodiment of the method, the lignocellulosic biomass feedstock is not contacted with a metal catalyst in the method, resulting in a dissolving cellulose free from metal catalyst.

Accordingly, in another aspect the invention relates to a dissolving cellulose, which is free from metal catalyst.

According to the invention, a lipophilic lignin oil can be obtained without affecting the performances nor the purity of the pulp.

In a further aspect the invention relates to a kit of products obtained by the inventive method.

Further advantages and embodiments will be apparent from the following detailed description and appended claims.

### DETAILED DESCRIPTION OF THE INVENTION

The lignocellulosic biomass feedstock which can be used in the inventive method can be selected in accordance with abundance. It is preferred that the particulate material is not too finely divided, as otherwise the quality of the dissolving cellulose obtained from the method may be compromised. When using sawdust, the viscosity of the resulting cellulose has been found to be too low. A course particulate lignocellulosic biomass feedstock should therefore be used. The term “course” is used herein to exclude a feedstock of finer particles, such as saw dust and powder. Preferably, the average size of the particles of the particulate lignocellulosic biomass feedstock used in the method should not be less than 1 mm×1 mm×15 mm. Suitable examples are chips, sticks and shavings. Suitable sources of the feedstock are for example fibrous plants such as hemp, fast-growing trees, such as poplar, and conifer trees, such as various species of pine and spruce. Also, damaged wood, such as for example wood from trees infested with various weevils or Scolytidae, such as bark beetle, and pine weevil can be used as the lignocellulosic biomass feedstock in the inventive method.

### Step C

In order for the lignin contained in the feedstock to be made available for extraction from the matrix of the biomass material of the feedstock, the feedstock is contacted with a solvent containing water. The contacting is performed under conditions in terms of temperature and pressure effective for removing hemicellulose contained in the lignocellulosic biomass feedstock, thereby freeing lignin contained in the lignocellulosic biomass feedstock from hemicellulose, and obtaining a solvent mixture containing hemicellulose and hemicellulose derived compounds, such as monomeric sugers. The conditions of temperature and pressure effective for removing hemicellulose during step C are typically a temperature within a range of 150-220° C. and a pressure within a range of 10-30 bar. The temperature is preferably within a range of 160-210° C., more preferably 170-200° C., and most preferably 180-190° C.

In preferred embodiments of step C an acidic catalyst, for promoting liberation of hemi-cellulose from the lignocellulosic biomass feedstock, is added to the solvent. Examples of suitable catalysts are mineral acids, formic acid, and carbonic acid, of which formic acid and carbonic acid are preferred, especially carbonic acid. Addition of carbonic acid to the solvent can be accomplished by adding pressurized carbon dioxide to the solvent. The carbon dioxide added in step C is preferably recycled in the inventive method. In preferred embodiments a mineral acid is not being used. For example, by the addition of CO₂, a mineral acid is not required.

The solvent used in step C has a water content of at least about 20% by volume. The remainder, if any, may for example be made up by a low-boiling organic compound, such as used in step E. Preferably an alcohol, more preferably ethanol or methanol, especially ethanol.

### Step E

Lignin thus freed can thereafter be extracted from the lignocellulosic biomass feedstock into a solvent comprising a liquid low-boiling organic compound. Examples of liquid low-boiling organic compounds that can be used are methanol, ethanol, propanols, butanols, dioxane, acetone, and ethyl acetate, more preferably methanol, ethanol, acetone, and ethyl acetate which all can easily be recovered by distillation. For this purpose the lignocellulosic biomass feedstock is contacted with a solvent comprising a low-boiling liquid organic compound. The contacting is performed under conditions in terms of temperature and pressure effective for removing lignin contained in the lignocellulosic biomass feedstock, which lignin has been freed from hemicellulose, thereby obtaining a solvent mixture containing lignin and lignin derived compounds, and a delignified lignocellulosic biomass feedstock. The conditions of temperature and pressure used during step E, may typically be similar to those of step C, i.e. typically a temperature within a range of 150-220° C. and a pressure within a range of 10-20 bar. The temperature is preferably within a range of 160-210° C., more preferably 170-200° C., and most preferably 180-190° C. The duration of step C is preferably within the range of 20-60 minutes, more preferably 20-40 minutes, and especially about 30 minutes.

In one embodiment, same solvent mixture is used in steps C and E. Accordingly, in such embodiment a solvent mixture comprising water and a low-boiling organic compound is used. The low-boiling organic compound must be miscible with water, such as methanol, ethanol, propanol, butanol, dioxane, acetone, and ethyl acetate. A lower alcohol is generally preferred as the low-boiling organic compound in this embodiment, such as ethanol and methanol, and especially ethanol. A suitable ratio of water to low-boiling organic compound is typically within a range of 4:1 to 1:4, such as 4:1, 3:1, 2:1, 1:1, 1:2, 1:3, and 1:4.

The solvent used in step E has a content of at least about 20% by volume of the low-boiling organic compound. The remainder, if any, may for example be made up by water, as used in step C. Preferably the low-boiling compound is an alcohol, more preferably ethanol or methanol, and especially ethanol.

By using the same solvent mixture for both of steps C and E, it will be possible to carry out said steps simultaneously. Accordingly, in one embodiment the contacting steps C and E are carried out simultaneously using one and the same solvent medium. That is, the first solvent and the second solvent are one and the same solvent mixture. A suitable solvent mixture is water and a low-boiling organic compound in a ratio of water to low-boiling compound of 1:4 to 4:1 by volume such as 4:1, 3:1, 2:1, 1:1, 1:2, 1:3, and 1:4, more preferably 3:1 to 1:3, and typically about 2:1 to 1:2 of the solvent mix, and especially preferred about 1:1. The contacting steps C and E are thus combined into one single contacting step. The conditions of temperature and pressure used during combined contacting step may typically be similar to those of step C and E above, i.e. typically a temperature within a range of 150-220° C. and a pressure within a range of 10-20 bar. The temperature is preferably within a range of 160-210° C., more preferably 170-200° C., and most preferably 180-190° C.

In embodiments wherein steps C and E are carried out separately using different solvents, it may be preferably to use merely water as the solvent for step C (i.e. in the absence of a low-boiling organic compound), and a low-boiling organic compound as solvent for step E (i.e. in the absence of water, or only as an impurity, such as due to hygroscopicity or azeotropic characteristics of the low-boiling organic compound). Thereby, the hemicellulose fraction, and lignin fraction can be obtained in higher purity separate from each other, thereby reducing the need for separation of the two fractions from each other. Also, the need for drying the lignin fraction, or separating water therefrom can thereby be reduced.

According to the invention the delignification in step E is carried out until a degree of delignification of the lignocellulosic biomass feedstock of up to 94% is accomplished, such as e.g. 88, 90 or 92%. It has been found that a higher degree of delignification will reduce the quality of the dissolving cellulose, and more particularly the viscosity thereof. A lower degree of delignification, on the other hand, will typically incur an increased need of bleaching in order to accomplish sufficient removal of remaining lignin. The degree of delignification can be established by methods commonly known in the art, such as Klason lignin measurement.

The duration of step E, whether combined with step C or not, should preferably not be overly long, since it has been found that a longer duration seems to result in a lower viscosity of the cellulose obtained. A duration of up to about 2 hours, and more preferably up to about 1 hour for step E is presently believed to be suitable. Accordingly, the conditions of temperature and pressure for step E should preferably be selected so that the desired degree of delignification will be achieved within about 2 hours, and more preferably within about 1 hour.

### Step F

A lignin oil can be separated out from the solvent mixture containing lignin and lignin derived compounds obtained in step E. This can be accomplished by merely removing the organic solvent used, such as by distillation. If a solvent containing water has been used in step E, the lignin oil will separate as an upper oily layer on the water phase upon removal of the organic solvent, which can simply be decanted or siphoned from the underlying water phase.

In order for a higher yield of lignin oil and a higher degree of depolymerization of the lignin to be obtained, the lignin and lignin derived compounds obtained in step E are subjected to conditions in terms of temperature and pressure effective for depolymerization of the lignin in the presence of a reducing catalyst, such as a transition metal catalyst. Thereby, a higher quality lignin oil having a more well-defined composition can be obtained. Examples of suitable catalysts are Pd, Ni, Co, Mo, Re, Cu, Ru, and mixtures thereof, especially Pd. The catalyst may be heterogenous, and can for example be supported on carbon. Suitable conditions of temperature and pressure effective for depolymerization of the lignin and lignin derived compounds are a temperature within the range of 150-250° C., more preferably 160-240° C., 170-230° C., and most preferably 180-220° C., and a pressure of less than 30 bar. The pressure will be dependent upon the specific solvent and temperature used. As an example, however, for a temperature in the range of 180-220° C., a pressure in the range of 10-30 bar will typically be sufficient, and for a temperature in the range of 190-210° C., a pressure in the range of 15-25 bar will typically be sufficient. While higher pressures could be used, it is usually sufficient to keep the pressure to up to 30 bar. The use of the above reducing catalyst will improve the yield of monophenolic compounds in the lignin oil. The use of a reducing catalyst in step E, especially in flow-through mode of step E, has been found also to result in a brighter pulp. By using a reducing catalyst in step E in flow-through mode operation of step E while avoiding contact of the catalyst with the lignocellulosic biomass feedstock, both a lipophilic lignin oil and a high quality dissolving cellulose can be obtained from the inventive method. The use of a catalyst in step E generally facilitates obtaining a pure cellulose, in that the resulting lignin oil more easily can be removed from the cellulose. However, when the course particulate lignocellulosic biomass feedstock used is derived from softwood, the benefit of using a catalyst in step E may not be substantial, as a sufficiently pure cellulose typically can be obtained also in the absence of a catalyst.

### Step G

In step G, the delignified lignocellulosic biomass feedstock resulting from step E is disintegrated so as to obtain an unbleached pulp. The means of disintegration is not critical and can for example be carried out using mechanical means, such as mechanical shearing means. The object of the disintegration is to release the fibres contained in the particles of the delignified lignocellulosic biomass feedstock from each other.

Preferably, the viscosity after of the pulp resulting from the disintegration is above 800 ml/g.

### Step H

In step H the unbleached pulp obtained in step G, is bleached so as to obtain a bleached pulp. In this step the remaining lignin in the lignocellulosic biomass feedstock from step E is removed by bleaching. For this step it is preferred that the degree of delignification in step E is not less than 80%. Accordingly, a preferred degree of delignification is within the range of from 80% up to 94%. The viscosity of the pulp resulting from the bleaching step H will typically have lower viscosity than that of the unbleached pulp resulting from step G.

The bleaching is preferably elemental chlorine-free (ECF), using e.g. NaClO₂, or totally chlorine free (TCF), using e.g. H₂O₂.

The bleaching should preferably be carried out so that a resulting ISO brightness of the pulp is at least 90%. The viscosity of the pulp after bleaching should be above 400 ml/g, and more preferably above 750 ml/g. As an example, for use in lyocell preparation a viscosity of at least 450 ml/g is typically required, while a viscosity of above 750 ml/g is required for viscose production.

### Step I

Depending on the specific desired specifications on the dissolving cellulose resulting from step H, especially as to metal content, and/or polydispersity index (PDI) of the dissolving cellulose, an additional step I preferably may preferably be included after step H, in which step I the bleached pulp is heated in an aqueous solution of a basic pH, and thereafter rinsed with EDTA. The heating temperature is typically about 70° C., and the pH is suitably within a range of 10-12. The treatment in step I reduces the polydispersity index of the pulp, and also reduces the metal content of the pulp. For example, the polydispersity index may be lower than 15, preferably lower than 10. The Fe content can thereby be reduced to below 10 ppm by weight of the pulp, and the Cu content can thereby be reduced to below 2 ppm by weight of the pulp.

It is preferred that any metal catalyst, when used in the inventive method, is not contacted with the lignocellulosic biomass feedstock during the process.

The system is preferably pressurized with N₂ or CO₂. Pressurization is especially preferred in flow-through mode, and particularly when steps C and E are combined using one and the same solvent.

Each one of the contacting steps C and E can independently be run batch-wise, or in flow-through mode, respectively, such as for example in a Soxhlet reactor. Flow-through mode is preferred for both steps, as this mode will not require mechanical stirring, and also subsequent washing steps are not required.

When run batch-wise, step C and step E can be carried out separately, using a first solvent in step C, and a second solvent in step E, respectively, or combined, using one and the same solvent.

In flow-through mode of step C the lignocellulosic biomass feedstock is contacted with a flow of solvent. In a preferred embodiment contacting step C is carried out using evaporated solvent from a heated solvent, such as for example in a Soxhlet extractor. The evaporated solvent is preferably condensed before being contacted with the lignocellulosic biomass feedstock. The heated condensed solvent having contacted the lignocellulosic biomass feedstock will be enriched in hemicellulose and hemicellulose derived compounds. In a preferred embodiment, the condensed solvent enriched in hemicellulose and hemicellulose derived compounds is returned to the heated liquid solvent phase containing the catalyst for another contacting cycle, until a desired degree of solvolysis of the hemicellulose has been accomplished.

In batch-wise operation of step C contact in is carried out in a mixture of lignocellulosic biomass feedstock and solvent, which mixture preferably is stirred.

In flow-through mode of step E the lignocellulosic biomass feedstock is contacted with a flow of solvent. In a preferred embodiment, the contacting step E, whether combined with C or not, is carried out using evaporated solvent from a heated solvent, such as for example in a Soxhlet extractor. Flow-through mode of step E is especially preferred when a reducing catalyst, such as a reducing metal catalyst is present in the solvent used, such as for depolymerization of lignin. The reducing catalyst present in the solvent can thereby be retained in the liquid phase, while the evaporated solvent will be free from catalyst. The evaporated solvent is preferably condensed before being contacted with the lignocellulosic biomass feedstock. The heated condensed solvent having contacted the lignocellulosic biomass feedstock will be enriched in lignin and lignin derived compounds. In a preferred embodiment, the condensed solvent enriched in lignin and lignin derived compounds is returned to the heated liquid solvent phase containing the catalyst for another contacting cycle, until a desired degree of delignification of the lignocellulosic biomass feedstock has been achieved. In this embodiment contact of the lignocellulosic biomass feedstock with a metal catalyst is avoided, and hence, contamination of the lignocellulosic biomass feedstock with a metal catalyst used in depolymerization of lignin can be avoided. Contamination of the pulp is undesirable especially since the metals used as catalysts may be toxic, and also from an economical view as the metal used is precious.

In batch-wise operation of step E contact is carried out in a mixture of lignocellulosic biomass feedstock and solvent, which mixture preferably is stirred. This embodiment is not suitable when a metal catalyst is used in step E, since the resulting dissolving cellulose will be contaminated by the catalyst.

After contacting step C, a washing step may be included for removing any reactants from the lignocellulosic biomass feedstock, thereby improving the purity of the lignocellulosic biomass feedstock after contacting step C. Such step is especially preferred if step C has been carried out batch-wise, such as in a mechanically stirred mixture of the first solvent and the lignocellulosic biomass feedstock.

After contacting step E, a washing step may be included for removing any reactants, and especially any remaining freed lignin, from the lignocellulosic biomass feedstock, thereby improving the purity of the lignocellulosic biomass feedstock resulting from contacting step E. Such step is especially preferred if step E has been carried out batch-wise, such as in a mechanically stirred mixture of the second solvent and the lignocellulosic biomass feedstock.

After contacting step E, a washing step may be included for removing any reactants, and especially any remaining freed lignin, from the lignocellulosic biomass feedstock, thereby improving the purity of the lignocellulosic biomass feedstock resulting from contacting step E. Such step is especially preferred if step E has been carried out batch-wise, such as in a mechanically stirred mixture of the second solvent and the lignocellulosic biomass feedstock.

In preferred embodiments, carbon dioxide is used to pressurize the system to the required level. The use of a CO₂ atmosphere has been found to have a beneficial impact on both delignification and removal of hemicellulose from the lignocellulosic biomass feedstock.

In especially preferred embodiments of the inventive method, contacting steps C and E are combined and are carried out in flow-through mode, using one and the same solvent for contact with the lignocellulosic biomass feedstock, wherein a reducing catalyst is present in the heated solvent mixture, from which solvent mixture solvent is being evaporated to be contacted with the lignocellulosic biomass feedstock. This embodiment is preferably carried out in a Soxhlet extractor.

The present invention will be illustrated by way of the following examples.

### EXAMPLES

### Example 1

General procedure for the inventive method when carrying out steps C and E in combination, using one and the same solvent in flow-through mode a Soxhlet extractor using a reducing catalyst.

Wood (5-19 g) in form of sticks was wrapped in porous containers made of either stainless steel net or cotton cloth and weighed. The containers filled with the wood substrate were positioned in the extraction cup. The solvent, aqueous EtOH (5-95 v %) 200 mL, was poured directly on the dry substrate to impregnated it with solvent. Pd/C in an amount of 5 wt % was added to the collecting cup as reducing catalyst (500-900 mg). The reactor was then sealed and the atmosphere adjusted to proper pressure and composition, 1-15 bar of either N₂ or CO₂. The cooling system (cold tap water) was set to 0.5-1.5 L/min and the temperature of the reactor was raised (180-220° C.). The reaction was considered started when the liquors in the collecting cup reached the set temperature. After the appropriate amount of time (2-6 h), the reaction was stopped by removing the heating source and, once at room temperature, the reactor was vented and opened. The reacted substrate was removed from the extracting cup, washed with acetone, and dried. The mass loss of both the substrate and the containers was measured by weighing.

The liquors contained in the collecting cup were filtrated, evaporated by the means of a rotary evaporator, weighed and collected as lignin oil.

The obtained reacted wood was washed with aqueous ethanol which was at the same concentration of ethanol as the original pulping liquor. The solvent washes were drained away and the wood material was transferred into a 2 L beaker which contains 1 L distilled water and was disintegrated into a homogeneous pulp by using T-25 digital ULTRA-TURRAX® Homogenizer with 20.4×1000 rpm for 15 min. The solvent was drained and the pulp was oven-dried to yield 44% yield.

The above disintegrated reacted wood was bleached with a 1:1 ratio of 1.7% aq. NaClO₂ and the mixture of 2.7% aq. NaOH, 7.5% acetic acid at 85° C. for 2 h with 1% pulp consistency. The degree of bleaching of the cellulose was established to correspond to a content of at least 98% glucose of the cellulose.

The lignin was liberated from the brown pulp under these conditions and the pulp turned into white pulp after single-stage bleaching. The obtained pulp was vacuum filtered and washed with distilled water three times (500 ml water in each wash). Finally, the bleached pulp was dried at room temperature for 2 days and stored in a sealed cover for further analysis with regard to brightness, viscosity, and alpha cellulose content.

### Example 2

In this example the resulting brown pulp composition was investigated when carrying out steps C and E in combination under the conditions set forth in Table 1, using one and the same solvent in batch-wise operation.

Beetle infected spruce (50 g, max size <5 cm) was loaded into a stainless steel reactor (volume capacity 250 ml). The solvent system of 65% EtOH in water (400 mL) was added followed by HCl solution (0.35 M, 6.25 mL). The reaction was heated with varied time and temperature to optimize pulp quality with stirring 300 rpm as set forth in Table 1. After completion, the reaction was cooled down to room temperature, then solid residue was filtrated and washed with acetone (200 mL) and water (500 mL). The solid residue was placed into 2 L beaker with 1 L of water then disintegrated into a homogeneous pulp by using T-25 digital ULTRA-TURRAX® Homogenizer with 17.0×1000 rpm for 10 min. The solvent was drained and the pulp was oven dried at 60° C. for 12 h to yield a brown pulp.

TABLE 1
Brown pulp composition for different
conditions of time and temperature

| | Yield | AIL | ASL | Glucose | Xylose | Total |
|---|---|---|---|---|---|---|
| Condition | (%) | (%) | (%) | (%) | (%) | (%) |
| 175° C., 3 h | 41.9 | 19.2 | 1.7 | 76.8 | 2.2 | 99.9 |
| 175° C., 4 h | 47.9 | 16.5 | 2.4 | 76.9 | 2.4 | 98.2 |
| 175° C., 5 h | 45.3 | 14.0 | 1.2 | 83.3 | 2.3 | 100.8 |
| 175° C., 6 h | 44.0 | 9.6 | 1.8 | 85.8 | 2.5 | 99.7 |
| 175° C., 7 h | 37.6 | 7.2 | 1.2 | 88.9 | 2.6 | 99.9 |
| 200° C., 0.5 h | 43.2 | 13.7 | 1.0 | 80.9 | 3.5 | 99.1 |
| 200° C., 1 h | 40.3 | 5.5 | 1.1 | 89.1 | 2.6 | 98.3 |
| 200° C., 2 h | 36.6 | 4.7 | 1.1 | 91.9 | 1.3 | 99.0 |
| 200° C., 3 h | 33.9 | 3.6 | 1.2 | 94.2 | 0.3 | 99.3 |
| 200° C., 4 h | 36.6 | 1.7 | 0.8 | 94.8 | nd | 97.3 |

AIL = acid insoluble lignin,
ASL = acid soluble lignin,
nd = not detected

### Example 3

Example 2 was repeated on a reduced scale, using 7 g of the beetle infected spruce. At pulping condition of 200° C. at 1 h, the reaction gave 3.26 g brown lignocellulose, corresponding to a yield of 46.5%. The lignin oil was extracted from the solvent system using EtOAc (3×40 mL). The crude lignin oil was dried over Na2SO4 and concentrated in vacuo. The amount of the resulting brown lignin oil was 1.52 g, corresponding to a yield of 21.8%.

### Example 4—Bleaching (Step H)

Brown pulp (10 g) from Example 2 (obtained at conditions 200° C., 1 h; 200° C., 2 h; 200° C., 3 h) was dissolved in 200 ml of solvent system containing 1.7% NaCIO2 solution and 2.7% NaOH in 7.5% acetic acid buffer at 1:1 ratio. The solution was heated at 85° C. for 2 h, then the solvent was replaced and the bleaching was continued for 1 h. After completion, the solution was cooled down to room temperature and the resulting white pulp was filtrated and washed with water (3×500 mL). The white pulp was dried at room temperature for 2 days and stored in dry condition for further analysis. The degree of bleaching of the cellulose was established to correspond to a content of at least 98% glucose of the cellulose. The results of Klason lignin and carbohydrate content are set forth in Table 2 below.

For the purpose of brightness measurements, a white pulp sheet (2.5 g) was prepared by filtration on Whatman filter paper (Pore size number 3 mm and 90 mm diameter) for each one of the three white pulps. The sheet was compressed and dried at room temperature for 2 days to give thin sheet of white pulp (5 mm thickness). The ISO-brightness was performed using Minolta Spectrophotometer CM-3630 with standard method ISO 2470-1. The results are presented in Table 2 below.

For the purpose of intrinsic viscosity measurements the procedure according to ISO 5351:2010 was performed for each one of the three white pulps. The results are contained in Table 2 below.

TABLE 2
Summary of white pulp composition analysis

| | Yield | | | | | | | |
|---|---|---|---|---|---|---|---|---|
| | from | | | | | | | |
| | bio- | | | | | | Bright- | Visco- |
| Condi- | mass | AIL | ASL | Glu | Xyl | Total | ness | sity |
| tion | (%) | (%) | (%) | (%) | (%) | (%) | (%) | (ml/g) |
| 200° C., | 36.3 | nd | 2.6 | 94.4 | 0.7 | 97.7 | 90.1 | 590 |
| 1 h | | | | | | | | |
| 200° C., | 28.9 | nd | 1.1 | 94.9 | 0.7 | 96.7 | 89.9 | 462 |
| 2 h | | | | | | | | |
| 200° C., | 30.3 | nd | 0.9 | 94.9 | 0.9 | 96.7 | 91.4 | 296 |
| 3 h | | | | | | | | |

nd = not detected

### Example 5

In this example steps C and E are carried out in combination using one and the same solvent in batch-wise operation using a reducing catalyst.

Poplar wood from the P. trichocarpa x P. trichocarpa clones, designated ‘OP42’ and ‘23.4’, respectively, were used. The wood was chipped into 2-4 cm long and ˜3 mm wide pieces to homogenize the samples. The wood (0.800 g×9) was pre-soaked in ethanol-water: 65%/35% (v/v) 10 mL for 12 h. To get enough yield of pulp, 9 reactors were run in parallel with 0.8 grams of wood per reactor. Then 0.36 N HCl 100 μL as catalyst was added each hydrothermal stainless-steel Swagelock metal reactor (14 ml capacity). 5% Pd/C catalyst (50 mg for 0.5 biomass loading) was added. In order to not contaminate the pulp with the catalyst, the initial biomass was caged in a paper basket. The method was run at 175° C. for 3 h; then the reactor was cooled down to room temperature. After completion of the reaction, the resulting delignified wood in the paper basket was removed and washed in 7:3 ethanol water to yield, after disintegration, 3.1 g (43% yield) with 2.8% Klason lignin for OP42 clone and 3.3 g (45%) with 3.1% Klason lignin for 23.4. It could be observed that the pulp appeared brighter as compared to when the reducing catalyst was not being used. The solvent fraction was filtered and concentrated in vacuum to yield a light brown oil in 22.5 wt % (an average for both clones). Quantification of lignin monomers is determined to 6-7% pulp wood.

### Example 6—Bleaching (Step H)

The poplar pulp (OP42 & 23.4) (10 g) obtained in Example 5 was extracted with a 2 M NaOH solution (E-stage) at 60° C. for 2 h. The alkaline solvent was filtrated off and the pulp was thoroughly washed with an excess of distilled water three times. After the washing, the brightness of the pulp was improved. In the second stage the pulp was bleached with a 1:1 ratio of 1.7% aq. NaClO₂ and the combination of 2.7% aq. NaOH, 7.5% acetic acid at 85° C. for 120 min with 0.86% pulp consistency. At this stage the bleaching solution turned into yellow which indicates the liberation of lignin from the pulp becoming brighter. The pulp solution was vacuum filtered and washed with distilled water for three times. Finally, the bleached pulp was dried at room temperature for two days and stored in a sealed cover for further analysis. The degree of bleaching of the cellulose was established to correspond to a content of at least 98% glucose of the cellulose.

Intrinsic viscosity measurements were performed on bleached ‘OP42’& ‘23.4’ pulp using standard method ISO 5351:2010. The intrinsic viscosity and degree of polymerization (DP) values for the bleached ‘OP42’ and ‘23.4’ were found to be 985 mL/g (DP=1478), and 1005 mL/g (DP=1511), respectively. A higher intrinsic viscosity is usually desirable, since a higher viscosity, if required, relatively easily can be reduced to a certain desired lower viscosity.

For the purpose of brightness measurements, laboratory pulp sheets were prepared. 400 ml of 1% suspension of the bleached ‘OP42’& ‘23.4’ pulps were used for making two different pulp sheets by vacuum filtration at 1.0 bar over Whatman filter paper (Pore size number 3 and 90 mm diameter). The cellulose cakes were placed between Whatman filter papers under 30 N load at room temperature for 30 min. This process was repeated with fresh Whatman filter papers until the cellulose filter cakes became dry. At the end, a 50 N load applied on both sheets for 3 days gave sheets wrinkle free sheets. Finally, the obtained pulp sheets (3 mm thickness with 4 cm diameter) were evaluated for brightness measurements.

The ISO-brightness test was performed on the ‘OP42’ and ‘23.4’ pulp sheets by using method ISO 2470-1 over Minolta Spectrophotometer model CM-3630, and the brightness value was determined to 90% ISO brightness observed for both the pulp sheets.

### Example 7

In this example steps C and E are carried out in combination using one and the same solvent in batch-wise operation using a reducing catalyst.

Raw hemp hurd (0.2 g), Pd/C 5% (20 mg), and 4 mL of MeOH:H₂O (7:3) containing 1.1 g/L p-TSA were added in a 7 mL steel reactor. Followed by addition of 80 mg of formic acid. The reaction was conducted at 200° C. The lignin oil was extracted by DCM, washed by water, and dried over anhydrous Na₂SO₄. The catalyst was filtered through celite. The collected organic phase was filtered and concentrated under reduced pressure. The crude was dissolved in 10 ml of acetonitrile and tetracosane as internal standard was added for GC-MS/FID analysis. The results exhibit peaks that correspond to 38.3 wt % yield (means value of three repetitions; 40.0, 38.2, 36.7 wt %) of monophenolic compounds (comprising i.a. syringylpropanol, syringylpropan, syringylpropen, syringylethane, guaiacolpropanol, guaiacolpropan, guaiacolpropen, guaiacolethane) under the optimized condition.

### Example 8

In this example steps C and E were carried out in combination using one and the same solvent in flow-through mode using a reducing catalyst while avoiding contact of the reducing catalyst with lignocellulosic biomass feedstock. A high-pressure Soxhlet extractor using carbon dioxide as a mild and recyclable acid catalyst was used. A liquid to wood ratio of 6.6 yielding 43% by weight of dissolving grade quality pulp from Populus Trichocarpa, a short rotation forestry derived hardwood. Prior art methods typically work with a liquid to wood ratio of 10˜20. The design of the reactor allowed using a heterogeneous catalyst to achieve reductive catalytic fractionation on the lignin oil without contaminating the final product with the catalyst nor reducing the performance.

Poplar wood sticks (approx. dimension 35×2×2 mm) was used. The reactor used consists of a 600 mL autoclave equipped with a gas valve, a thermocouple and a cooling coil. A collecting cup and above this, an extraction cup equipped with a syphon which unloads directly into the collecting cup are placed inside the autoclave. The conditions used were a targeted biomass loading of 9.7 g of the wood sticks in the EC and filling the CC with 200 ml of EtOH:H₂O mixture 1:1 setting the temperature at 220° C. and the cooling flow rate of 1 L/min which was the maximum allowed the equipment used. By adding 8 barg of inert nitrogen gas at room temperature, the system reached an operating pressure of approximately 25˜30 barg at 220° C. Under these conditions, water is just below its boiling point, resulting in more controlled evaporation of the solvent mixture. However, pulping efficiency measured by loss of weight resulted in a poor 37.3 wt % from the aimed ≈50 wt % even after 4 hours. By analysis of the generated pulp, 15% of lignin and 10% hemicellulose were still present showing an uncomplete pulping.

A similar run was repeated wherein an acid was added to promote the hydrolysis of hemicellulose and the release of lignin. Accordingly, carbon dioxide, which is easy recoverable, was used as the acid source. The atmosphere in the reactor was changed into CO₂ aiming at a lower pH of the liquors by adding 8 barg at room temperature. In this run a 48.3 wt % mass loss and high purity of the reacted wood were observed. Comparison of the results under N₂ and CO₂ atmospheres shows that CO₂ has a beneficial impact on both delignification and removal of hemicellulose from the solid residues. The chemical analysis of the product obtained under the run with added CO₂ showed a high purity pulp containing 94 wt % of glucose and traces of lignin (3 wt %) and xylose (3 wt %). The water content was screened and the optimal solvent composition was found to be 25 v/v % of EtOH in H₂O. The low amount of alcohol needed, 50 mL, is due to the fact that the EC can only accommodate approximately 100 ml of solvent when holding the substrate containers. Therefore the liquor composition in the extraction cup, before being unloaded, is highly enriched in the solvent with the lower boiling point, i.e. EtOH. The effective pulping solvent concentration was estimated to be approximately 50 v/v % of EtOH in H₂O. The reaction gave optimal results after 4 hours. 1 L/min was used as the cooling flow rate in order to secure sufficient cooling. The degree of removal of lignin and hemicellulose was found to be independent of the loading of the substrate. This can be explained by the fact that the pulping liquors, which get in contact with the substrate, are always freshly distilled and therefore extremely diluted. Under optimized conditions the wood sticks yielded 51.7 wt % of dry substance (Table 3 entry 1).

TABLE 3
Solvent recycling study.

| | Mass loss | Loading | Lignin | Glucose | Xylose |
|---|---|---|---|---|---|
| Entry | [wt %] | [g] | [wt %] | [wt %] | [wt %] |
| 1 | 48.3 | 9.7 | 3 | 94 | 3 |
| 2 | 48.3 | 10.2 | 6 | 89 | 5 |
| 3 | 49.1 | 10.5 | 4 | 90 | 2 |
| 4 | 47.1 | 11.4 | 6 | 89 | 4 |

Reaction conditions: 220° C., 4 h, cooling flow 1 L/min, 200 ml of EtOH:H₂O 1:3, 8 bar of CO₂ at RT.

Recycling of the spent liquids was performed by running a series of subsequent reactions where the liquors were reused and the containers with treated sticks exchanged for ones carrying fresh substrate. The solvent system was recycled up to three times with a small refill to compensate for the loss due to the removal of the wet reacted wood bags, always maintaining the operational volume of 200 ml (Table 3, entries 2-4). The yields in term of delignification and hemicellulose removal were slightly lower but consistent with the previous runs. Thus, the treated solid material obtained from those three runs were combined to be used in the next step. Therefore, 30.1 g of poplar wood was treated with a mere 200 mL of solvent (50 ml of EtOH and 150 ml of water) reaching a liquid to wood ratio of 6.6 and an organic solvent to wood ratio of 1.66. To achieve the final product, i.e. dissolving grade pulp, the fibres contained in the delignified wood needed to be released from each other. This was obtained by using an automatic disintegrator. The procedure yielded unbleached pulp in 44 wt % yield compared to initial wood, 85 wt % yield from the previous step. During this step the purity of the pulp further increased to reach the optimal 94 wt % of glucose (Table 4, column C).

TABLE 4
Chemical composition of poplar 23.4 along the process.

| | A | B | C | D |
|---|---|---|---|---|
| Material | Raw sticks | Treated sticks | Pulp | Bleached pulp |
| Lignin* | 25 | 3 | 3 | <1 |
| [wt %] | | | | |
| Glucose** | 42 | 94 | 94 | 98 |
| [wt %] | | | | |
| Xylose** | 12 | 3 | 3 | 2 |
| [wt %] | | | | |

*Klason lignin (ASL + AIL),
**determined by NMR.

Consequently, elemental chlorine-free (ECF) bleaching was performed on the pulp by using a 1:1 ratio of sodium chlorite and a NaOH/AcOH buffer solution to obtain 43 wt % of bleached pulp, 98 wt % yield from the unbleached pulp. A sheet made of bleached material was analysed by following the standard method ISO 2470-1 resulting in more than 91% of ISO-brightness. a-cellulose was quantified and a high value (90.58%) was found. The bleached material was further tested for viscosity (442 mL/g) and DP (610) complying with the requirement for lyocell production.

After the reaction, the liquors were collected, filtrated, and evaporated under vacuum to remove the solvents yielding an oil containing lignin as the product. In the attempt to valorise the lignin fraction, which is produced in the extracting cup as a by-product of the solvolysis and constantly unloaded in low concentration in the collecting cup, a reducing catalyst was used. The procedure of combining pulping with reductive catalysis is commonly known as reductive catalytic fractionation (RFC). The pulping reactor allowed us to add a heterogeneous catalyst to the collecting cup without contaminating the pulp which remains always confined in the extracting cup. The goal was to use the collecting cup as a catalytic reactor in parallel with the pulping run in the extracting cup while exploiting the same heat source. The so-called organosolv liquor (i.e. the liquor obtained when steps C and E are combined using one and the same solvent) contains mono/oligomeric fractions of lignin, which are highly reactive compounds prone to re-condensate. The heterogeneous catalyst under reducing conditions is able to transform these fragments into stable and valuable compounds through hydrodeoxygenation/reduction. Commercially available Pd/C was selected as the heterogeneous catalyst and no external source of hydrogen was added. The reaction with 4 mol % of Pd gave 17 wt % of lignin oil in respect to the initial biomass. The lignin oil was further analysed by GC-MS/FID and 2 wt % of monophenolic compounds, which are derivatives of syringol and guaiacol, in respect to the biomass were detected while no monomers were detected in absence of the catalyst.

An organosolv (corresponding to a combination of contacting steps C and E into one step using one and the same solvent) performed in a high-pressure Soxhlet extractor has been developed. The reactor produced delignified pulp overcoming the need for any mineral acid, dewaxing, mechanical stirring or late washing steps. Only a source of heat and a cooling flow under CO₂ atmosphere is required. The system used is able to process up to 32.1 g of wood with only 200 ml of solvent (50 ml of which is ethanol) with a liquid to wood ratio of 6.6 yielding 13.8 g of dissolving grade quality pulp with an average delignification of 97% without any acidic pre-treatment. CO₂ was found to have an active role in the pulping performance, due to the influence on the pH and consequently on the cleavage of lignin carbohydrate complexes. The resulting material was treated to yield bleached pulp with chemical and physical properties within the range of dissolving grade pulp, with a final yield of 43 wt % in respect to the initial biomass weight. By adding Pd/C to the reactor, reductive catalytic fractionation was operated on the lignin achieving an oil without affecting the quality of the final product nor the pulping performance of the system.

### Example 9

### Liquid Hot Water (LHW) Pre-Treatment of Birch Wood

Reactions were conducted in an autoclave reactor (10 mL). Birch wood chips (0.5 g) were added in the reactor with water (5 mL). The autoclave reactor was and sealed and placed into oil bath at 180-200° C. under stirring. After 10-60 min the reactor was cooled down and opened. The reaction mixture was collected and filtered. The collected solid fraction was dried at 60° C. overnight and weighed. The filtrate was concentrated into vacuum to perform future analysis.

### Xylose Content Determination

The xylose content of the filtrate was determined by high-performance liquid chromatography (HPLC). Calibration was performed with standard solutions of D-(+)-xylose.

To perform HPLC analysis of the filtrate, a slightly modified National Renewable Energy Labs (NREL) two-step hydrolysis procedure was applied: The dried sample (0.1-0.2 g) was added together with 72 wt % H₂SO₄ (2 mL) and placed into pressure tube and incubating at 30° C. for 1 h and then diluted to 4 wt % H₂SO₄ by adding water. The mixture was placed in a round-bottom flask. Under reflux conditions, the mixture was incubated a second time for 1 h in an oil bath at 121° C. After completion, the reaction was cooled down, filtered and neutralized by adding NaHCO₃. The neutralized solution was filtered and subjected to HPLC.

TABLE 5
Liquid Hot Water (LHW) pre-treatment of birch wood

| | | | Yield of | Yield of | | *furfural |
|---|---|---|---|---|---|---|
| | | | xylose, | xylose, | | content, |
| | | | wt % | wt % based | | wt % |
| | | | based on | on xylan | | based on |
| T, | t, | | dry wood | content | Sample | dry wood |
| ° C. | min | solvent | (HPLC) | (HPLC) | name | (GC-FID) |
| 180 | 60 | water | 7.5 | 28.8 | DL- | 2.47 |
| | | | | | LHW-3 | |
| 180 | 10 | water | 0.4 | 1.5 | DL- | nd |
| | | | | | LHW-6 | |
| 180 | 40 | water | 3.4 | 13 | DL- | nd |
| | | | | | LHW-8 | |
| 200 | 40 | water | 6.5 | 24.9 | DL- | nd |
| | | | | | LHW-7 | |

### Example 10

In the example, steps C and E were carried out in sequence. A reducing catalyst was not used in step E.

### Liquid Hot Water Pre-Treatment (Step C)

5.0 g of birch wood chips was placed in a 400 mL stainless steel reactor followed by addition of 100 mL of distilled water. The reaction was conducted at 180° C. for 30 min. After completion, the reaction was cooled and solid residues were filtered, air-dried and used for the next step. The water phase was analysed by HPLC and showed xylose in about 60% by weight of theoretical yield.

### Delignification (Step E)

0.7 g of pre-treated wood was placed in a 15 mL stainless steel reactor followed by addition of 10 ml of EtOH (60% by weight aq) and 0.2 mL of 0.35 M HCl solution. The reaction was conducted at 200° C. for 1 h. After completion (at 90% delignification, as established using Klason lignin measurement), the reaction was cooled and solid residues were filtered, air-dried and used for the next step. The organic phase was dried and contained lignin oil (0.14 g).

### Bleaching (Step H)

0.5 g of unbleached pulp resulting from step E was submerged in 50 mL bleaching solution (25 ml of 1.7% NaClO₂+2.7% NaOH and 25 ml 7.5% acetic acid). The mixture was stirred at 60° C. for 2 h. After completion, the pulp was washed with distilled water, filtered, air-dried, and collected for brightness and viscosity test.

### Dissolving Pulp Characteristics Results

After sequential extraction, pulp brightness was 90%, and the viscosity of the pulp was 600 ml/g.

1. A method of producing dissolving cellulose and lignin oil from a lignocellulosic biomass feedstock in particulate form comprising the following steps:
A providing a particulate lignocellulosic biomass feedstock;
B providing a first solvent comprising water;
C contacting the lignocellulosic biomass feedstock with the first solvent under conditions in terms of temperature and pressure effective for removing hemicellulose contained in the lignocellulosic biomass feedstock, thereby freeing lignin contained in the lignocellulosic biomass feedstock from hemicellulose, and obtaining a solvent mixture containing hemicellulose and hemicellulose derived compounds;
D providing a second solvent comprising a low-boiling liquid organic compound;
E contacting the lignocellulosic biomass feedstock with the second solvent under conditions in terms of temperature and pressure effective for removing lignin contained in the lignocellulosic biomass feedstock, which lignin has been freed from hemicellulose, thereby obtaining a solvent mixture containing lignin and lignin derived compounds, and a delignified lignocellulosic biomass feedstock;
F separating out a lignin oil from the solvent mixture containing lignin and lignin derived compounds obtained in step E;
G disintegrating the delignified lignocellulosic biomass feedstock resulting from step E, so as to obtain an unbleached pulp;
H bleaching of the unbleached pulp obtained in step G, so as to obtain a bleached pulp;
wherein the particulate lignocellulosic biomass feedstock is in the form of a course particulate lignocellulosic biomass feedstock, and the delignification in step E is carried out until a degree of delignification of the lignocellulosic biomass feedstock of up to 94% is accomplished.

2. The method of claim 1, wherein an acidic catalyst for facilitating liberation of the hemicellulose from the lignocellulosic biomass feedstock is added to the solvent in step C.

3. The method of claim 1, wherein one and the same solvent mixture comprising water and a low-boiling liquid organic compound is used as the first and second solvents.

4. The method of claim 1, wherein the low-boiling liquid organic compound is methanol and/or ethanol.

5. The method of claim 1, additionally comprising a depolymerization step wherein the lignin and lignin derived compounds obtained in step E are subjected to conditions in terms of temperature and pressure effective for depolymerization of the lignin in the presence of a reducing catalyst.

6. The method of claim 5, wherein the reducing catalyst is not contacted with the lignocellulosic biomass feedstock during the method.

7. The method of claim 1, wherein the degree of delignification of the lignocellulosic biomass feedstock in step E is at least 80%.

8. The method of claim 1, wherein pressurized CO₂ is added to the solvent as an acidic catalyst in step C.

9. The method of claim 1, wherein step C and/or step E is run batch-wise.

10. The method of claim 1, wherein step C and/or step E is run in flow-through mode, preferably in a Soxhlet extractor.

11. The method of claim 1, wherein the pressure does not exceed 30 bar.

12. The method of claim 1, wherein wood chips and/or wood sticks are used as the lignocellulosic biomass feedstock.

13. A dissolving cellulose free from metallic catalyst, obtainable by means of the method of claim 1.

14. A set of products obtained by the method of claim 1, comprising a dissolving cellulose free from metallic catalyst, and a lipophilic lignin oil.

15. The set of products of claim 14, additionally comprising hemicellulose and hemicellulose derived compounds.
